(19) United States
(12) Patent Application Publication
(10) Pub. No.: US 2022/0282929 A1
(43) Pub. Date: Sep. 8, 2022

(54) COOLING CHANNEL STRUCTURE, BURNER, AND HEAT EXCHANGER

(71) Applicant: MITSUBISHI HEAVY INDUSTRIES, LTD., Tokyo (JP)

(72) Inventors: Tatsuya KAMEYAMA, Tokyo (JP); Yuta TAKAHASHI, Tokyo (JP); Yoshitaka NAKAYAMA, Tokyo (JP); Toshiyuki YAMASHITA, Tokyo (JP); Yasuharu CHUMAN, Tokyo (JP); Shuji TANIGAWA, Tokyo (JP); Takafumi SHINOGI, Tokyo (JP); Ryuhei TAKASHIMA, Tokyo (JP)

(21) Appl. No.: 17/637,286

(22) PCT Filed: Jan. 24, 2020
(86) PCT No.: PCT/JP2020/002547

§ 371 Date: Feb. 22, 2022

(30) Foreign Application Priority Data
Sep. 13, 2019 (JP) 2019-166731

(51) Int. Cl. F28D 7/10; F23D 14/78

(52) U.S. Cl. CPC F28D 7/10; F23D 14/78

(57) ABSTRACT

Provided are a first wall section extending along a first direction, a second wall section disposed at an interval from the first wall section in a second direction orthogonal to the first direction, and a plurality of partition wall sections connecting the first wall section and the second wall section so as to form at least one cooling channel between the first wall section and the second wall section, the cooling channel having a plurality of channel cross-sections disposed at intervals in the first direction. In a cross-section including the first direction and the second direction, at least a part of each of the partition wall sections extends along a direction intersecting with the second direction.

### TECHNICAL FIELD

The present disclosure relates to a cooling channel structure, a burner, and a heat exchanger.

### BACKGROUND

Patent Document 1 discloses a fuel nozzle shroud which internally includes a cooling channel linearly extending along the axial direction. With the above configuration, by flowing a cooling medium to the cooling channel, it is possible to reduce a thermal stress caused in the fuel nozzle shroud.

### CITATION LIST

### Patent Literature

Patent Document 1: JP2015-206584A

### SUMMARY

### Technical Problem

Meanwhile, regarding a cooling channel for cooling an object to be cooled, if a plurality of channel cross-sections are disposed at intervals between two wall sections facing each other in a direction along wall surfaces, in the wall section of the above-described two wall sections exposed to a high-temperature fluid, a large thermal stress is caused at a connection position with a partition wall section partitioning the above-described plurality of channel cross-sections, which may cause damage. However, Patent Document 1 described above does not disclose any knowledge for the above problem and a solution thereto.

In view of the above, an object of the present disclosure is to provide a cooling channel structure, a burner, and a heat exchanger capable of suppressing damage caused by the thermal stress.

### Solution to Problem

In order to achieve the above object, a cooling channel structure according to the present disclosure includes a first wall section extending along a first direction, a second wall section disposed at an interval from the first wall section in a second direction orthogonal to the first direction, and a plurality of partition wall sections connecting the first wall section and the second wall section so as to form at least one cooling channel between the first wall section and the second wall section, the cooling channel having a plurality of channel cross-sections disposed at intervals in the first direction. In a cross-section including the first direction and the second direction, at least a part of each of the partition wall sections extends along a direction intersecting with the second direction.

### Advantageous Effects

According to the present disclosure, provided are a cooling channel structure, a burner, and a heat exchanger capable of suppressing damage caused by a thermal stress.

### BRIEF DESCRIPTION OF DRAWINGS

FIG. 1 is a vertical cross-sectional view showing the schematic configuration of a burner 2 according to an embodiment.

FIG. 2 is a vertical cross-sectional view showing the schematic configuration of a burner tube 5 (5A) according to an embodiment, and shows a cross-section including a center axis CL (a cross-section including the axial direction and the radial direction) of the burner tube 5 (5A).

FIG. 3 is a vertical cross-sectional view showing the schematic configuration of the burner tube according to a comparative embodiment.

FIG. 4 is a partially enlarged view of the configuration shown in FIG. 3.

FIG. 5 is a partially enlarged view of the configuration shown in FIG. 2.

FIG. 6 is a vertical cross-sectional view showing the schematic configuration of a burner tube 5 (5B) according to another embodiment, and shows a cross-section including the center axis CL (the cross-section including the axial direction and the radial direction) of the burner tube 5 (5B).

FIG. 7 is a vertical cross-sectional view showing the schematic configuration of a burner tube 5 (5C) according to another embodiment, and shows a cross-section including the center axis CL (the cross-section including the axial direction and the radial direction) of the burner tube 5 (5C).

FIG. 8 is a partially enlarged view of the configuration shown in FIG. 6.

FIG. 9 is a partially enlarged view of the configuration shown in FIG. 7.

FIG. 10 is a vertical cross-sectional view showing the schematic configuration of a burner tube 5 (5D) according to another embodiment, and shows a cross-section including the center axis CL (the cross-section including the axial direction and the radial direction) of the burner tube 5 (5D).

FIG. 11 is a vertical cross-sectional view showing the schematic configuration of a burner tube 5 (5E) according to another embodiment, and shows a cross-section including the center axis CL (the cross-section including the axial direction and the radial direction) of the burner tube 5 (5E).

FIG. 12 is a partial cross-sectional view showing the schematic configuration of a nozzle skirt 50 of a rocket engine according to another embodiment.

FIG. 13 is a partial cross-sectional view of the schematic configuration of a cooling channel structure 100G according to another embodiment.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

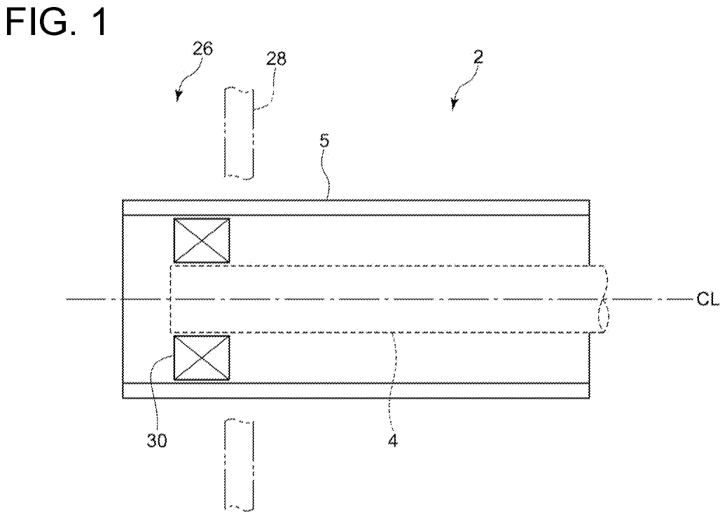

FIG. 1 is a vertical cross-sectional view showing the schematic configuration of a burner 2 according to an embodiment. The burner 2 is applied to, for example, a gasification furnace for a coal gasification device or the like, a conventional boiler, an incinerator, a gas turbine combustor, or an engine.

The burner 2 includes a fuel nozzle 4 for injecting fuel, and a burner tube 5 Disposed around the fuel nozzle 4 on the same axis CL as the fuel nozzle 4, for guiding air serving as an oxidant for combusting the fuel. The burner tube 5 is a tubular member having openings at both ends, respectively, and functions as a shield tube for shielding heat. A swirler 30 is disposed between the outer peripheral surface of the fuel nozzle 4 and the inner peripheral surface of the burner tube 5. The burner tube 5 is disposed to penetrate a wall 28 of a combustion chamber 26 where flame is formed. The proximal end side of the burner tube 5 is located outside the combustion chamber 26, and the distal end side of the burner tube 5 is located inside the combustion chamber 26. On the proximal end side of the burner tube 5, for example, a flange or the like may be provided which is to be connected to an air supply pipe (not shown) for supplying air.

Hereinafter, the axial direction of the burner tube 5 will simply be referred to as the “axial direction”, the radial direction of the burner tube 5 will simply be referred to as the “radial direction”, and the circumferential direction of the burner tube 5 will simply be referred to as the “circumferential direction”. Further, hereinafter, an inner portion of the burner tube 5 means a thick inner portion of the burner tube 5.

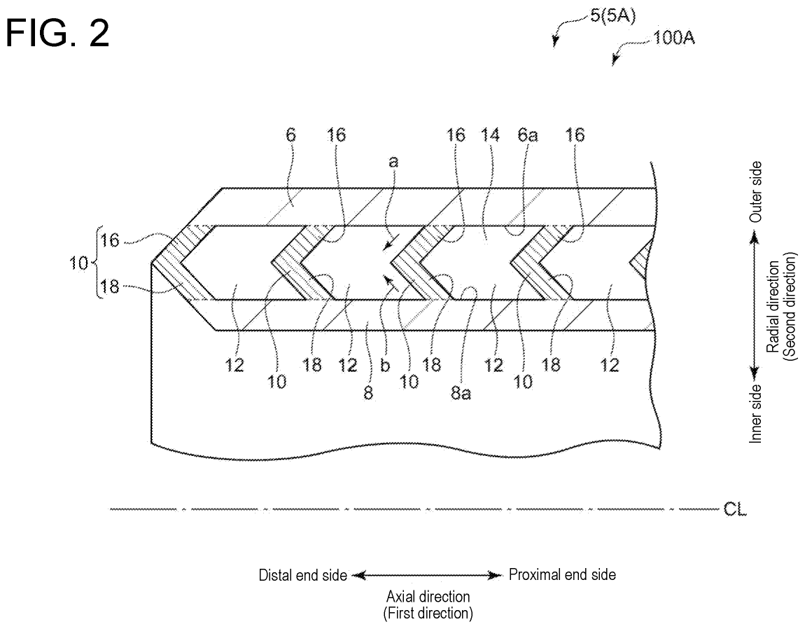

Next, a configuration example of the burner tube 5 will be described with reference to FIG. 2. FIG. 2 is a vertical cross-sectional view showing the schematic configuration of a burner tube 5 (5A) according to an embodiment, and shows a cross-section including the center axis CL (a cross-section including the axial direction and the radial direction) of the burner tube 5 (5A).

As shown in FIG. 2, the burner tube 5 (5A) includes a tubular first wall section 6 extending along the axial direction serving as the first direction, a tubular second wall section 8 disposed at an interval from the first wall section 6 in the radial direction (a thickness direction of the burner tube 5) serving as the second direction orthogonal to the first direction, at least one cooling channel 14, and a plurality of partition wall sections 10 connecting the first wall section 6 and the second wall section 8. The tubular second wall section 8 is disposed on the inner peripheral side of the tubular first wall section 6, and the center axis CL of the first wall section 6 coincides with a center axis of the second wall section 8. In the cross-section shown in FIG. 2, the first wall section 6 and the second wall section 8 are disposed parallel to each other.

The plurality of partition wall sections 10 connect the first wall section 6 and the second wall section 8 so as to form the at least one cooling channel 14, which has a plurality of channel cross-sections 12 disposed at intervals in the axial direction, between the first wall section 6 and the second wall section 8. That is, each of the partition wall sections 10 is disposed in the cooling channel 14, extends from the first wall section 6 to the second wall section 8 along the radial direction, and forms a wall surface of the cooling channel 14. Each of the partition wall sections 10 has a radially outer end connected to a surface 6a of the first wall section 6 on the side of the second wall section 8 (the inner peripheral surface of the first wall section 6). Each of the partition wall sections 10 has a radially inner end connected to a surface 8a of the second wall section 8 on the side of the first wall section 6 (the outer peripheral surface of the second wall section 8). That is, the first wall section and the second wall section 8 are connected via the plurality of partition wall sections 10. The at least one cooling channel 14 may be, for example, one spiral channel, a plurality of spiral channels, or one or a plurality of channels with various other shapes adopted for a heat exchanger and the like.

In the cross-section shown in FIG. 2, at least a part of each partition wall section 10 extends along a direction intersecting with the radial direction. In the cross-section shown in FIG. 2, each of the channel cross-sections 12 has an arrow shape including a substantially triangle, and each of the partition wall sections 10 includes a first inclined wall portion 16 linearly extending from the first wall section 6 along a direction a (third direction) intersecting with the radial direction, and a second inclined wall portion 18 linearly extending from the second wall section 8 along a direction b (fourth direction) intersecting with each of the radial direction and the direction a to be connected to the first inclined wall portion 16. In the illustrated cross-section, the direction a is a direction toward the distal end side of the burner tube 5 in the axial direction from the first wall section 6 toward the radially inner side, and the direction b is a direction toward the distal end side of the burner tube 5 in the axial direction from the second wall section 8 toward the radially outer side.

In the configuration shown in FIG. 2, the first wall section 6, the second wall section 8, and the plurality of partition wall sections 10 constitute a cooling channel structure 100A including the at least one cooling channel 14. That is, the at least one cooling channel 14, through which a cooling medium for cooling the burner tube 5 (5A) flows, is formed in the inner portion of the burner tube 5 (5A) itself (the thick inner portion of the burner tube 5), and the burner tube 5 (5A) itself constitutes the cooling channel structure 100A. Such burner tube 5 (5A) can be produced by using, for example, a three-dimensional additive manufacturing device (so-called 3D printer). The cooling medium flowing through the cooling channel 14 may be, for example, a liquid such as water or oil, or a gas such as air.

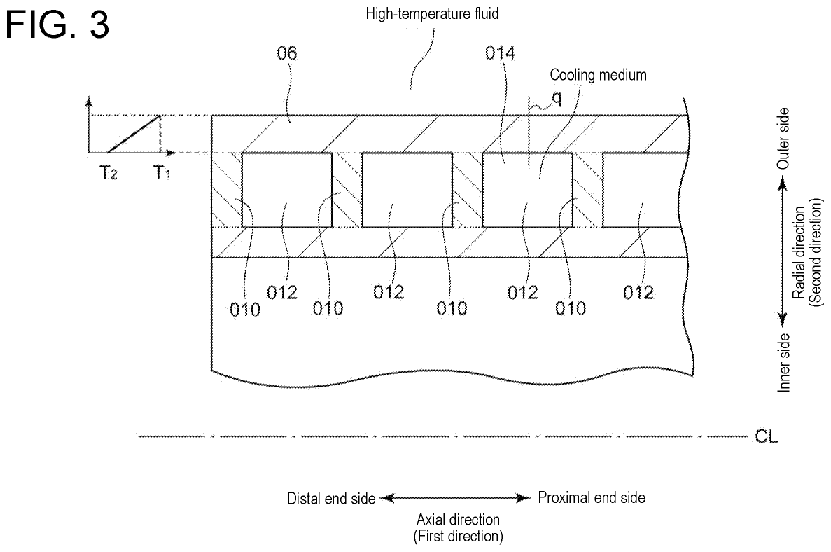

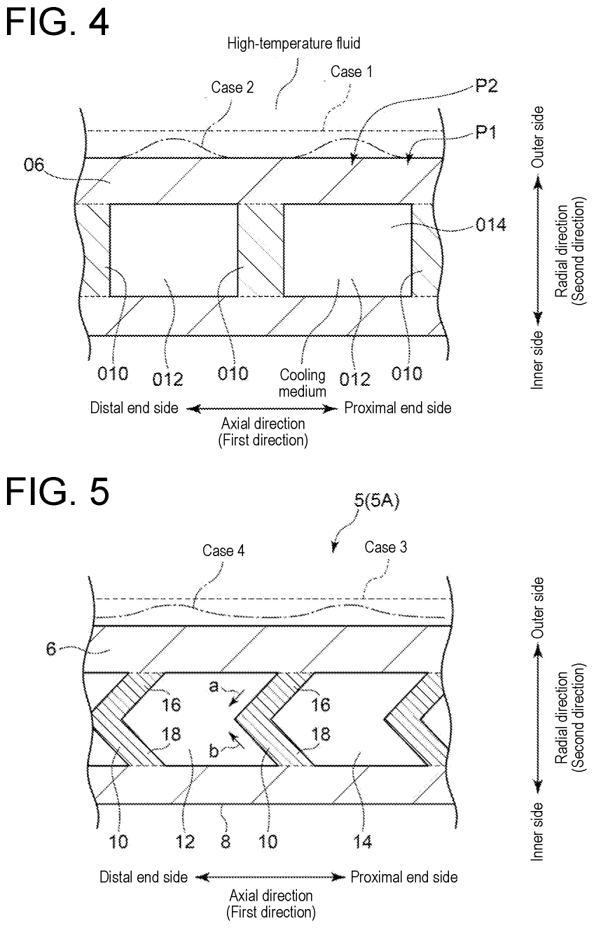

Herein, an effect obtained by the configuration shown in FIG. 2 will be described with reference to FIGS. 3 to 5. FIG. 3 is a vertical cross-sectional view showing the schematic configuration of the burner tube according to a comparative embodiment. FIG. 4 is a partially enlarged view of the configuration shown in FIG. 3. FIG. 4 schematically shows a thermal deformation amount of a first wall section 06 in the radial direction by a dashed line with regard to a virtual case (case 1) where the first wall section 06 receives no constraint of thermal deformation from partition wall sections 010, and schematically shows a thermal deformation amount of the first wall section 06 in the radial direction by a single-dotted chain line with regard to an actual case (case 2) where the first wall section 06 receives the constraint of thermal deformation from the partition wall sections 010. FIG. 5 is a partially enlarged view of the configuration shown in FIG. 2. FIG. 5 schematically shows a thermal deformation amount of a first wall section 6 in the radial direction by a dashed line with regard to a virtual case (case 3) where the first wall section 6 receives no constraint of thermal deformation by partition wall sections 10, and schematically shows a thermal deformation amount of the first wall section 6 in the radial direction by a single-dotted chain line with regard to an actual case (case 4) where the first wall section 6 receives the constraint of thermal deformation by the partition wall sections 10.

As shown in FIG. 3, in a device for performing heat exchange, in the first wall section 06 located between the high-temperature fluid and the cooling medium (a low-temperature fluid having a lower temperature than the high-temperature fluid), a temperature gradient (a temperature gradient with a temperature distribution ranging from a temperature T₂ to a temperature T₁ shown in FIG. 3) is generated in the thickness direction of the first wall section 06, and thermal deformation is caused by a temperature increase due to a heat flux q from the high-temperature fluid. Meanwhile, the partition wall sections 010, respectively, partitioning channel cross-sections 012 of a cooling channel 014 are interposed between the cooling media, the temperature of the partition wall sections 010 is the same as that of the cooling media.

As shown in FIG. 4, the first wall section 06 is not connected to the partition wall section 010 at a position P2 away from the partition wall section 010 in the axial direction, and thus does not directly receive no constraint of thermal deformation from the partition wall section 010 at the position P2, whereas the first wall section 06 is connected to the partition wall section 010 at a position P1 where the partition wall section 010 exists in the axial direction, and thus directly receives the constraint of thermal deformation from the partition wall section 010 at the position P1. Thus, a large thermal stress is caused in a portion of the first wall section 06 connected to the partition wall section 010 (a portion in the vicinity of the position P1), which may cause damage.

By contrast, in the burner tube 5 (5A) shown in FIGS. 2 and 5, as described above, at least the part of each partition wall section 10 extends along the direction intersecting with the radial direction. Thus, compared with the respective configurations shown in FIGS. 3 and 4, it is possible to suppress the damage to the first wall section 6 by reducing a constraint force of thermal deformation received from the partition wall section 10 by the first wall section 6 (the constraint force received by the portion of the first wall section 6 connected to the partition wall section 10), while maintaining the density of the cooling channel 14.

Further, as described above, each of the partition wall sections 10 includes the first inclined wall portion 16 extending from the first wall section 6 along the direction a intersecting with the radial direction, and the second inclined wall portion 18 extending from the second wall section 8 along the direction b intersecting with each of the radial direction and the direction a to be connected to the first inclined wall portion 16. Thus, each of the channel cross-sections 12 has the arrow shape including the substantially triangle, implementing high pressure resistance and low pressure loss of the cooling channel 14, as well as making it possible to suppress an increase in thermal stress caused in the first wall section 6.

Next, some other embodiments will be described. In other embodiments to be described below, unless otherwise stated, common reference characters with those for the respective constituent components in the aforementioned embodiments denote the same constituent components as those for the respective constituent components in the aforementioned embodiments, and the description thereof will be omitted.

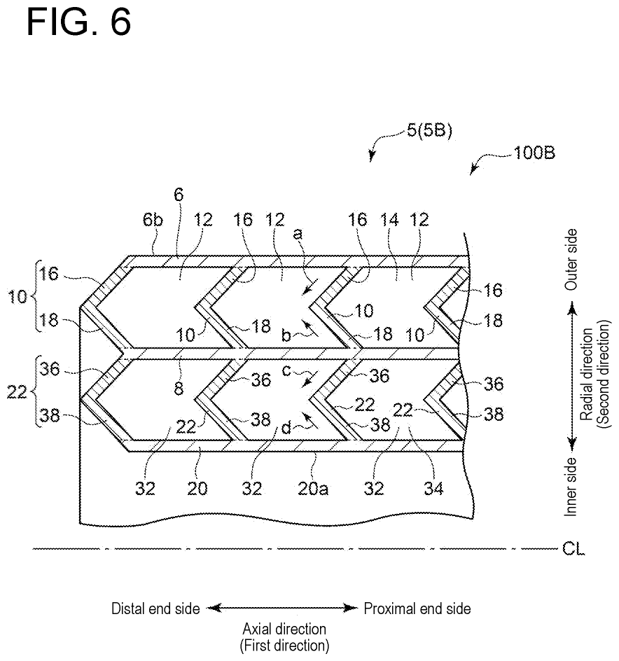

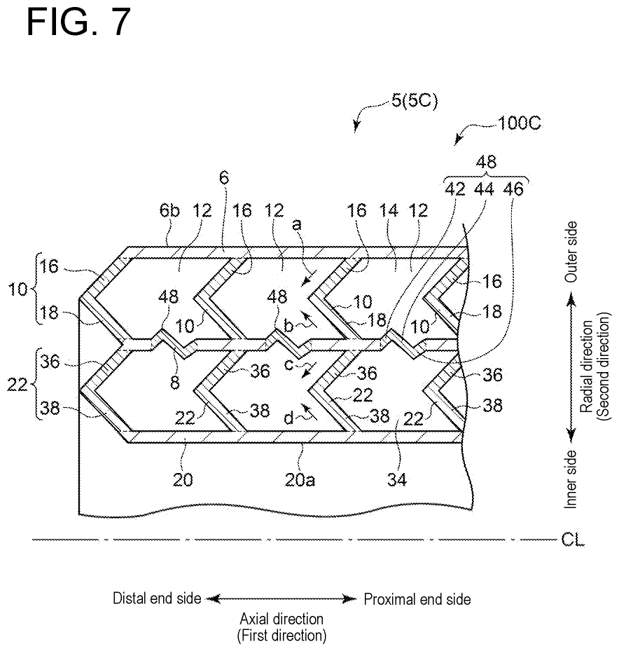

FIG. 6 is a vertical cross-sectional view showing the schematic configuration of a burner tube 5 (5B) according to another embodiment, and shows a cross-section including the center axis CL (the cross-section including the axial direction and the radial direction) of the burner tube 5 (5B). FIG. 7 is a vertical cross-sectional view showing the schematic configuration of a burner tube 5 (5C) according to another embodiment, and shows a cross-section including the center axis CL (the cross-section including the axial direction and the radial direction) of the burner tube 5 (5C).

The burner tube 5 (5B) shown in FIG. 6 further includes a third wall section 20 and a plurality of partition wall sections 22, in addition to the first wall section 6, the second wall section 8, and the plurality of partition wall sections 10 described above.

The third wall section 20 is disposed opposite to the first wall section 6 across the second wall section 8, and extends along the axial direction. In the configuration shown in FIG. 6, a surface 6b of the first wall section 6 on a side opposite to the second wall section 8 faces a high-temperature fluid in the combustion chamber 26, and a surface 20a of the third wall section 20 on the side opposite to the second wall section 8 faces the high-temperature fluid in the combustion chamber 26.

The plurality of partition wall sections 22 connect the second wall section 8 and the third wall section 20 so as to form the at least one cooling channel 34, which has a plurality of channel cross-sections 32 disposed at intervals in the axial direction, between the second wall section 8 and the third wall section 20.

In the cross-section shown in FIG. 6, at least a part of each partition wall section 22 connecting the second wall section 8 and the third wall section 20 extends along the direction intersecting with the radial direction. In the cross-section shown in FIG. 6, each of the partition wall sections 22 includes a third inclined wall portion 36 linearly extending from the second wall section 8 along a direction c intersecting with the radial direction, and a fourth inclined wall portion 38 linearly extending from the second wall section 8 along a direction d intersecting with each of the radial direction and the direction c to be connected to the third inclined wall portion 36. In the illustrated cross-section, the direction c is a direction toward the distal end side of the burner tube 5 in the axial direction from the second wall section 8 toward the radially inner side, and the direction d is a direction toward the distal end side of the burner tube 5 in the axial direction from the third wall section 20 toward the radially outer side.

In the configuration shown in FIG. 6, the first wall section 6, the second wall section 8, the third wall section 20, the plurality of partition wall sections 10, and the plurality of partition wall sections 22 constitute a cooling channel structure 100B including the cooling channels 14, 34. That is, the cooling channels 14 and 34, through which the cooling medium for cooling the burner tube 5 (5B) flows, are formed in the inner portion of the burner tube 5 (5B) itself (the thick inner portion of the burner tube 5), and the burner tube 5 (5B) itself constitutes the cooling channel structure 100B.

With the configuration shown in FIG. 6, since at least the part of each partition wall section 10 connecting the first wall section 6 and the second wall section 8 extends along the direction intersecting with the radial direction, it is possible to suppress the damage to the first wall section 6 by reducing the constraint force of the thermal deformation received from the partition wall section 10 by the first wall section 6, while maintaining the density of the cooling channel 24. Further, since at least the part of each partition wall section 22 connecting the second wall section 8 and the third wall section 20 extends along the direction intersecting with the radial direction, it is possible to suppress damage to the third wall section 20 by reducing a constraint force of thermal deformation received from the partition wall section 22 by the third wall section 20, while maintaining the density of the cooling channel 34.

In the configuration shown in FIG. 6, the first wall section 6 and the third wall section 20 are heated by the high-temperature fluid and thermal deformation (thermal expansion) is caused in the axial direction, whereas the second wall section 8 is interposed between the cooling media and cooled, constraining the axial thermal deformation of the first wall section 6 and the third wall section 20 by the second wall section 8, and causing the thermal stress.

By contrast, in the burner tube 5 (5C) shown in FIG. 7, in the cross-section including the axial direction and the radial direction, at least a part of the second wall section 8 extends along the direction intersecting with the axial direction. Thus, the constraint force of the axial thermal deformation received from the second wall section 8 by the first wall section 6 and the third wall section 20 is reduced, making it possible to suppress the damage to the first wall section 6 and the third wall section 20.

Further, in the cross-section shown in FIG. 7, the second wall section 8 includes, at the same pitch as the partition wall sections 10, a plurality of connecting portions 40, and a plurality of bent wall portions 48 each including a fifth inclined wall portion 42, a sixth inclined wall portion 44, and a seventh inclined wall portion 46. The connecting portions 40 are connected to the partition wall sections 10 and the partition wall sections 22, respectively.

The fifth inclined wall portion 42 linearly extends toward the radially outer side toward the proximal end side of the burner tube 5 in the axial direction. One end of the fifth inclined wall portion 42 is connected to the connecting portion 40, and another end of the fifth inclined wall portion 42 is connected to one end of the sixth inclined wall portion 44. The sixth inclined wall portion 44 linearly extends toward the radially inner side toward the proximal end side of the burner tube 5 in the axial direction, and another end of the sixth inclined wall portion 44 is connected to one end of the seventh inclined wall portion 46. The seventh inclined wall portion 46 linearly extends toward the radially outer side toward the proximal end side of the burner tube 5 in the axial direction, and another end of the seventh inclined wall portion 46 is connected to the adjacent connecting portion 40.

In the configuration shown in FIG. 7, the first wall section 6, the second wall section 8, the third wall section 20, the plurality of partition wall sections 10, and the plurality of partition wall sections 22 constitute a cooling channel structure 100C including the cooling channels 14, 34. That is, the cooling channels 14 and 34, through which the cooling medium for cooling the burner tube 5 (5C) flows, are formed in the inner portion of the burner tube 5 (5C) itself (the thick inner portion of the burner tube 5), and the burner tube 5 (5C) itself constitutes the cooling channel structure 100C.

In the configuration shown in FIG. 7, since the second wall section 8 includes the above-described bent wall portions 48, it is possible to effectively reduce the constraint force of the axial thermal deformation received from the second wall section 8 by the first wall section 6 and the third wall section 20.

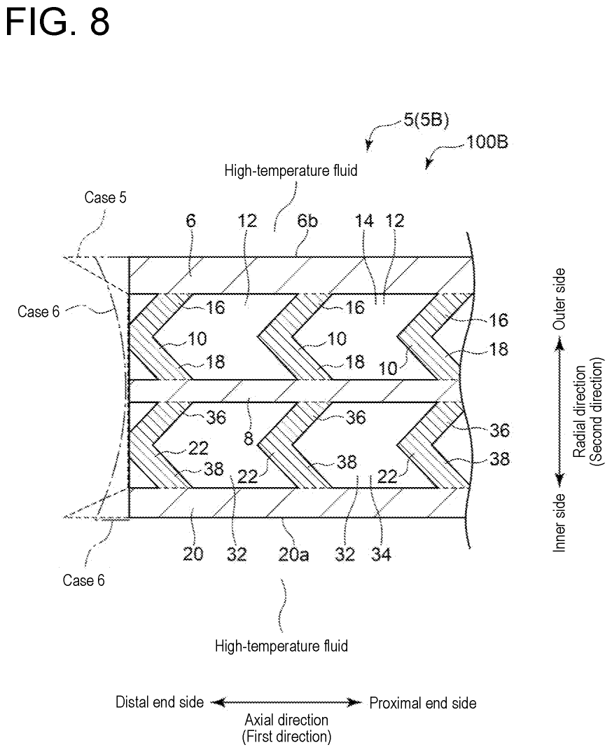

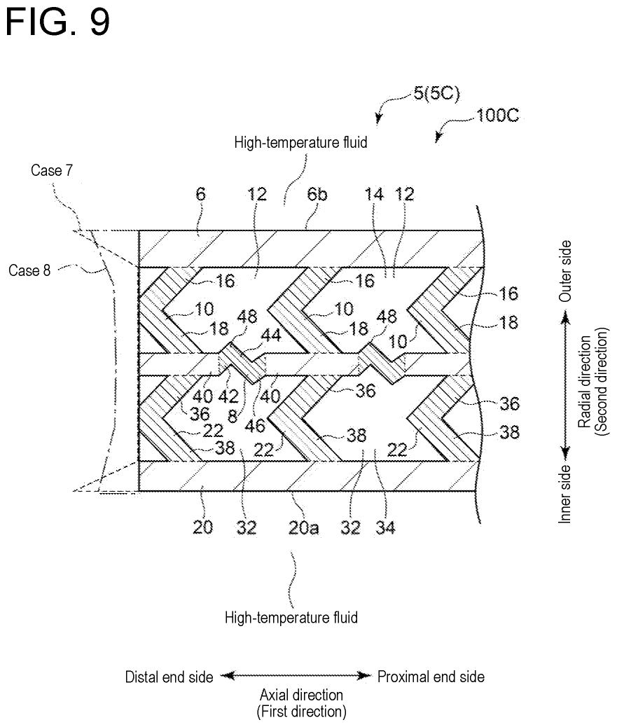

FIG. 8 is a partially enlarged view of the configuration shown in FIG. 6. FIG. 8 schematically shows a thermal deformation amount in the axial direction by a dashed line with regard to a virtual case (case 5) where thermal deformation is not constrained, and schematically shows a thermal deformation amount in the axial direction by a single-dotted chain line with regard to an actual case (case 6) where thermal deformation is constrained. FIG. 9 is a partially enlarged view of the configuration shown in FIG. 7. FIG. 9 schematically shows a thermal deformation amount in the axial direction by a dashed line with regard to a virtual case (case 7) where thermal deformation is not constrained, and schematically shows a thermal deformation amount in the axial direction by a single-dotted chain line with regard to an actual case (case 8) where thermal deformation is constrained.

Comparing FIGS. 8 and 9, compared with the virtual case (case 5, case 7) where thermal deformation is not constrained, the thermal deformation amount of the first wall section 6 and the third wall section 20 are constrained and reduced in the actual case (case 6, case 8) where thermal deformation is constrained. Further, the constraint force of the axial thermal deformation received from the second wall section 8 by the first wall section 6 and the third wall section 20 is smaller in the configuration shown in FIG. 9 than in the configuration shown in FIG. 8, compared with case 6 shown in FIG. 8, the axial thermal deformation amount of the first wall section 6, the second wall section 8, and the third wall section 20 is large in case 8. Thus, it is possible to further reduce the thermal stress caused in the first wall section 6 and the third wall section 20 in the configuration shown in FIG. 9 than in the configuration shown in FIG. 8, and to suppress the damage to the first wall section 6 and the third wall section 20.

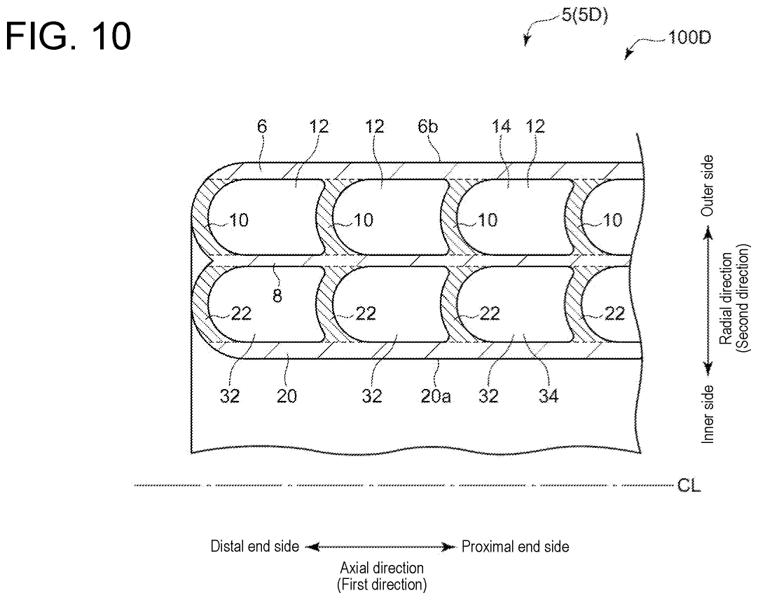

FIG. 10 is a vertical cross-sectional view showing the schematic configuration of a burner tube 5 (5D) according to another embodiment, and shows a cross-section including the center axis CL (the cross-section including the axial direction and the radial direction) of the burner tube 5 (5D).

Each of the channel cross-sections 12, 32 has the arrow shape including the substantially triangle in the configuration shown in FIG. 6, whereas each of the channel cross-sections 12, 32 has the arrow shape including a substantially semicircle in the configuration shown in FIG. 10.

In the cross-section shown in FIG. 10, each of the partition wall sections 10 is formed along an arc, and at least the part of the partition wall section 10 extends along the direction intersecting with the radial direction. Further, in the cross-section shown in FIG. 10, each of the partition wall sections 22 is formed along an arc, and at least the part of the partition wall section 22 extends along the direction intersecting with the radial direction.

Thus, in the configuration shown in FIG. 10, the first wall section 6, the second wall section 8, the third wall section 20, the plurality of partition wall sections 10, and the plurality of partition wall sections 22 constitute a cooling channel structure 100D including the cooling channels 14, 34. That is, the cooling channels 14 and 34, through which the cooling medium for cooling the burner tube 5 (5D) flows, are formed in the inner portion of the burner tube 5 (5D) itself (the thick inner portion of the burner tube 5), and the burner tube 5 (5D) itself constitutes the cooling channel structure 100D.

In the configuration shown in FIG. 10 as well, since at least the part of each partition wall section 10 extends along the direction intersecting with the radial direction, it is possible to suppress the damage to the first wall section 6 by reducing the constraint force of the thermal deformation received from the partition wall section 10 by the first wall section 6, while maintaining the density of the cooling channel 14. Further, since at least the part of each partition wall section 22 extends along the direction intersecting with the radial direction, it is possible to suppress damage to the third wall section 20 by reducing the constraint force of thermal deformation received from the partition wall section 22 by the third wall section 20, while maintaining the density of the cooling channel 34.

Further, forming each of the partition wall sections 10 along the arc, compared with the configuration shown in FIG. 6, it is possible to suppress an increase in pressure loss of the cooling channel 14 while increasing pressure resistance of the cooling channel 14. Further, forming each of the partition wall sections 22 along the arc, compared with the configuration shown in FIG. 6, it is possible to suppress an increase in pressure loss of the cooling channel 14 while increasing pressure resistance of the cooling channel 34.

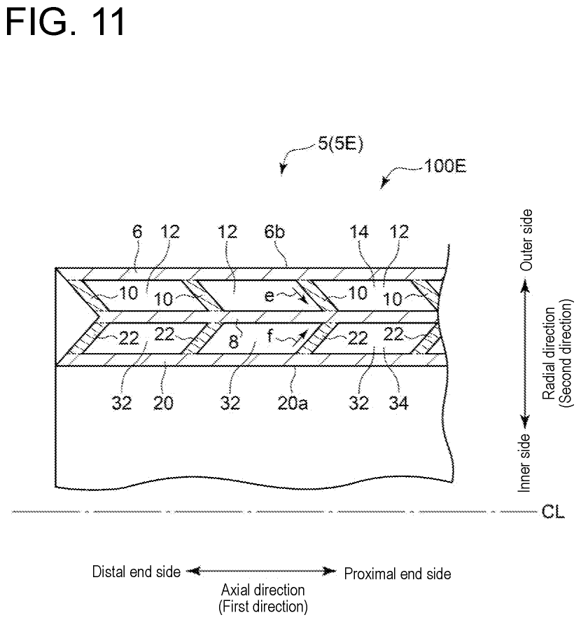

FIG. 11 is a vertical cross-sectional view showing the schematic configuration of a burner tube 5 (5E) according to another embodiment, and shows a cross-section including the center axis CL (the cross-section including the axial direction and the radial direction) of the burner tube 5 (5E).

Each of the channel cross-sections 12, 32 has the arrow shape including the substantially triangle in the configuration shown in FIG. 6, whereas each of the channel cross-sections 12, 32 has a substantially parallelogram in the configuration shown in FIG. 11.

In the cross-section shown in FIG. 11, each of the partition wall sections 10 linearly extends from the first wall section 6 to the second wall section 8 along a direction e intersecting with the radial direction. Further, in the cross-section shown in FIG. 11, each of the partition wall sections 22 linearly extends from the third wall section 20 to the second wall section 8 along a direction f intersecting with the radial direction. In the illustrated cross-section, the direction e is a direction toward the proximal end side of the burner tube 5 in the axial direction from the first wall section 6 toward the radially inner side, and the direction f is a direction toward the proximal end side of the burner tube 5 in the axial direction from the third wall section 20 toward the radially outer side.

Thus, in the configuration shown in FIG. 11, the first wall section 6, the second wall section 8, the third wall section 20, the plurality of partition wall sections 10, and the plurality of partition wall sections 22 constitute a cooling channel structure 100C including the cooling channels 14, 34. That is, the cooling channels 14 and 34, through which the cooling medium for cooling the burner tube 5 (5E) flows, are formed in the inner portion of the burner tube 5 (5E) itself (the thick inner portion of the burner tube 5), and the burner tube 5 (5E) itself constitutes the cooling channel structure 100E.

In the configuration shown in FIG. 11 as well, since at least the part of each partition wall section 10 extends along the direction intersecting with the radial direction, it is possible to suppress the damage to the first wall section 6 by reducing the constraint force of the thermal deformation received from the partition wall section 10 by the first wall section 6, while maintaining the density of the cooling channel 14. Further, since at least the part of each partition wall section 22 extends along the direction intersecting with the radial direction, it is possible to suppress the damage to the third wall section 20 by reducing the constraint force of thermal deformation received from the partition wall section 22 by the third wall section 20, while maintaining the density of the cooling channel 34.

Further, since the partition wall sections 10 extend from the first wall section 6 to the second wall section 8 along the direction e intersecting with the radial direction, compared with the configuration shown in FIG. 6 and the configuration shown in FIG. 10, it is possible to effectively suppress the damage to the first wall section 6 by effectively reducing the constraint force of thermal deformation received from the partition wall sections 10 by the first wall section 6.

Further, since the partition wall sections 22 extend from the third wall section 20 to the second wall section 8 along the direction f intersecting with the radial direction, compared with the configuration shown in FIG. 6 and the configuration shown in FIG. 10, it is possible to effectively suppress the damage to the third wall section 20 by effectively reducing the constraint force of thermal deformation received from the partition wall sections 22 by the third wall section 20.

The present disclosure is not limited to the above-described embodiments, and also includes an embodiment obtained by modifying the above-described embodiments and an embodiment obtained by combining these embodiments as appropriate.

For example, in some embodiments described above, the cases where the burner tubes 5 (5A to 5E) constitute the cooling channel structures 100A to 100E, respectively, have been exemplified. The same cooling channel structure as the above cooling channel structures may be applied to a nozzle skirt of a rocket engine.

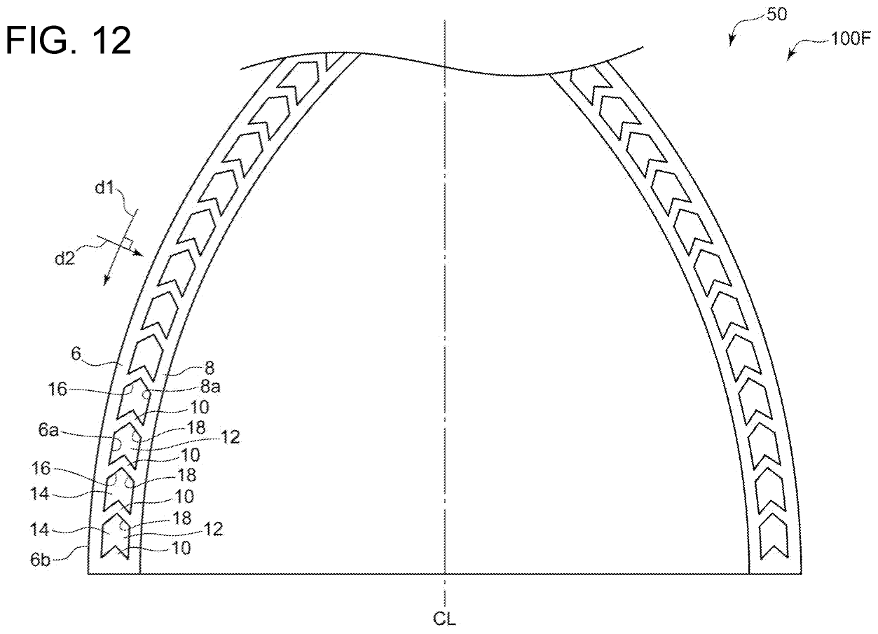

FIG. 12 is a partial cross-sectional view showing the schematic configuration of a nozzle skirt 50 of a rocket engine according to another embodiment.

The nozzle skirt 50 of the rocket engine shown in FIG. 12 is formed into a tubular shape and includes the tubular first wall section 6 extending along a first direction d1, the tubular second wall section 8 disposed at the interval from the first wall section 6 in a second direction d2 (a thickness direction of the nozzle skirt 50) orthogonal to the first direction d1, and the plurality of partition wall sections 10 connecting the first wall section 6 and the second wall section 8. The tubular second wall section 8 is disposed on the inner peripheral side of the tubular first wall section 6, and the center axis CL of the first wall section 6 coincides with the center axis CL of the second wall section 8. The radius of the tubular first wall section 6 and the radius of the tubular second wall section 8 increase toward the distal end side (the lower side of the drawing) of the nozzle skirt 50.

The plurality of partition wall sections 10 connect the first wall section 6 and the second wall section 8 so as to form the at least one cooling channel 14, which has the plurality of channel cross-sections 12 disposed at intervals in the first direction d1, between the first wall section 6 and the second wall section 8.

In the configuration shown in FIG. 12, the first wall section 6, the second wall section 8, and the plurality of partition wall sections 10 constitute a cooling channel structure 100F including the at least one cooling channel 14. That is, the cooling channel 14, through which the cooling medium for cooling the nozzle skirt 50 flows, is formed in the inner portion of the nozzle skirt 50 itself (the thick inner portion of the nozzle skirt 50), and the nozzle skirt 50 itself constitutes the cooling channel structure 100F.

In the cross-section shown in FIG. 12, since at least the part of each partition wall section 10 extends along the direction intersecting with the second direction d2, it is possible to suppress the damage to the first wall section 6 by reducing the constraint force of the thermal deformation received from the partition wall section 10 by the first wall section 6, while maintaining the density of the cooling channel 14.

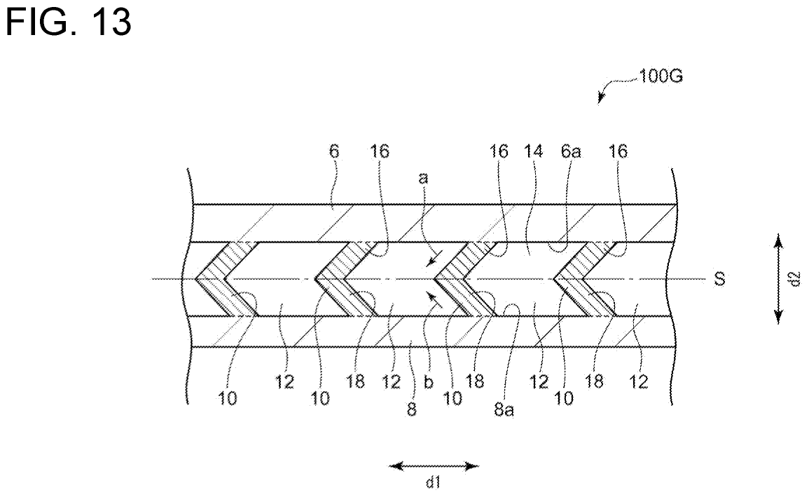

Further, in some embodiments described above, the cases where the tubular members constitute the cooling channel structures 100A to 100F, respectively, have been exemplified. That is, the cases where the first wall section 6 and the second wall section 8 are each formed into the tubular shape have been exemplified. However, in other embodiments, each of the first wall section 6 and the second wall section 8 is not limited to have the cylindrical shape but may have, for example, a tubular shape with a polygonal cross-section, and for example, as shown in FIG. 13, each of the first wall section 6 and the second wall section 8 may be formed in parallel to a plane S along the plane S. In this case, at least a part of each partition wall section 10 extends along a direction intersecting with the direction (second direction) orthogonal to the plane S.

In the cross-section shown in FIG. 13, each of the channel cross-sections 12 has the arrow shape including the substantially triangle, and each of the partition wall sections 10 includes the first inclined wall portion 16 linearly extending from the first wall section 6 along the direction a (third direction) intersecting with the radial direction, and the second inclined wall portion 18 linearly extending from the second wall section 8 along the direction b (fourth direction) intersecting with each of the radial direction and the direction a to be connected to the first inclined wall portion 16. In the illustrated cross-section, the direction a is a direction toward one side in the direction d1 with increasing distance from the first wall section 6, and the direction b is a direction toward the above-described one side in the first direction with increasing distance from the second wall section 8.

In the configuration shown in FIG. 13, the first wall section 6, the second wall section 8, and the plurality of partition wall sections 10 constitute a cooling channel structure 100G including the at least one cooling channel 14. The cooling channel structure 100G shown in FIG. 13 is applicable to, for example, a water wall of a boiler furnace or the like. With the configuration shown in FIG. 13, the constraint force of the thermal deformation received from the partition wall section 10 by the first wall section 6 is reduced, making it possible to suppress the damage to the first wall section 6.

Further, in some embodiments described above, the configuration has been exemplified in which the first wall section 6 and the second wall section 8 (and the third wall section 20) are arranged in parallel. However, the first wall section 6 and the second wall section 8 (and the third wall section 20) may not necessarily be arranged in parallel.

The contents described in the above embodiments would be understood as follows, for instance.

(1) A cooling channel structure (100A to 100G) according to the present disclosure includes a first wall section (such as the above-described first wall section 6 of each embodiment) extending along a first direction (such as the axial direction in the burner tube 5 (5A to 5E), the first direction d1 in the nozzle skirt 50, and the first direction d1 in the water wall 52 described above), a second wall section (such as the above-described second wall section 8 of each embodiment) disposed at an interval from the first wall section in a second direction (such as the radial direction in the burner tube 5 (5A to 5E), the second direction d2 in the nozzle skirt 50, and the second direction d2 in the water wall 52 described above) orthogonal to the first direction, at least one cooling channel (such as the above-described at least one cooling channel 14 of each embodiment) which has a plurality of channel cross-sections (such as the above-described plurality of channel cross-sections 12 of each embodiment) disposed at intervals in the first direction, the cooling channel being formed between the first wall section and the second wall section, and a plurality of partition wall sections (such as the above-described plurality of partition wall sections 10 of each embodiment) disposed in the cooling channel, connecting the first wall section and the second wall section, and forming a wall surface of the cooling channel. In a cross-section including the first direction and the second direction, at least a part of each of the partition wall sections extends along a direction (such as the direction a, b, e and the direction along the arc in the embodiment shown in FIG. 10 described above) intersecting with the second direction.

With the cooling channel structure according to the above configuration (1), since at least the part of each of the partition wall sections extends along the direction intersecting with the second direction, compared with the configuration where the partition wall section extends in parallel to the second direction (the direction orthogonal to the first direction), it is possible to suppress the damage to the first wall section caused by the thermal stress by reducing the constraint force of the thermal deformation received from the partition wall section by the first wall section, while maintaining the density of the cooling channel.

(2) In some embodiments, in the cooling channel structure according to the above configuration (1), in the cross-section including the first direction and the second direction, each of the partition wall sections is formed along an arc.

With the cooling channel structure according to the above configuration (2), since each of the partition wall sections is formed along the arc, it is possible to implement the cooling channel structure which is particularly favorable in terms of pressure resistance and pressure loss of the cooling channel.

(3) In some embodiments, in the cooling channel structure according to the above configuration (1), in the cross-section including the first direction and the second direction, each of the partition wall sections includes a first inclined wall portion (such as the above-described first inclined wall portion 16) extending from the first wall section in a third direction (such as the above-described direction a) intersecting with the second direction, and a second inclined wall portion (such as the above-described second inclined wall portion 18) extending from the second wall section in a fourth direction (such as the above-described direction b) intersecting with each of the second direction and the third direction to be connected to the first inclined wall portion.

With the cooling channel structure according to the above configuration (3), since each of the channel cross-sections of the cooling channel has the shape including the substantially triangle, it is possible to implement the cooling channel structure which is favorable in terms of pressure resistance of the cooling channel, in terms of the pressure loss of the cooling channel, and in terms of the thermal stress caused in the first wall section.

(4) In some embodiments, in the cooling channel structure according to the above configuration (3), each of the partition wall sections includes the first inclined wall portion and the second inclined wall portion, and the third direction is a direction toward one side in the first direction with increasing distance from the first wall section, and the fourth direction is a direction toward the above-described one side in the first direction with increasing distance from the second wall section.

With the cooling channel structure according to the above configuration (4), since each of the channel cross-sections of the cooling channel has the shape including the substantially triangle, it is possible to implement the cooling channel structure which is favorable in terms of pressure resistance of the cooling channel, in terms of the pressure loss of the cooling channel, and in terms of the thermal stress caused in the first wall section.

(5) In some embodiments, in the cooling channel structure according to the above configuration (1), in the cross-section including the first direction and the second direction, the partition wall sections extend from the first wall section to the second wall section in a direction (such as the above-described direction e) intersecting with the second direction.

With the cooling channel structure according to the above configuration (5), it is possible to implement the cooling channel structure which is particularly favorable in terms of the thermal stress caused in the first wall section.

(6) In some embodiments, in the cooling channel structure according to any one of the above configurations (1) to (5), each of the first wall section and the second wall section is formed into a tubular shape, and the second wall section is disposed on an inner peripheral side of the first wall section.

With the cooling channel structure according to the above configuration (6), it is possible to suppress damage caused by the thermal stress in the tubular structure.

(7) In some embodiments, in the cooling channel structure according to any one of the above configurations (1) to (5), each of the first wall section and the second wall section is formed along a plane (such as the above-described plane S).

With the cooling channel structure according to the above configuration (7), it is possible to suppress damage caused by the thermal stress in the structure along the plane.

(8) In some embodiments, in the cooling channel structure according to any one of the above configurations (1) to (7), the cooling channel structure further includes a third wall section (such as the above-described third wall section 20) disposed opposite to the first wall section across the second wall section, and a plurality of partition wall sections (such as the above-described plurality of partition wall sections 22) connecting the second wall section and the third wall section so as to form at least one cooling channel (such as the above-described at least one cooling channel 34) between the second wall section and the third wall section, the cooling channel having a plurality of channel cross-sections (such as the above-described plurality of channel cross-sections 32) disposed at intervals in the first direction. In the cross-section including the first direction and the second direction, at least a part of each of the partition wall sections connecting the second wall section and the third wall section extends along the direction (such as the direction c, d, f and the direction along the arc in the embodiment shown in FIG. 10 described above) intersecting with the second direction.

With the cooling channel structure according to the above configuration (8), since at least the part of each of the partition wall sections connecting the second wall section and the third wall section extends along the direction intersecting with the second direction, compared with the configuration where the partition wall section extends in parallel to the second direction (the direction orthogonal to the first direction), it is possible to suppress the damage to the third wall section caused by the thermal stress by reducing the constraint force of the thermal deformation received from the partition wall section by the third wall section, while maintaining the density of the cooling channel.

(9) In some embodiments, in the cooling channel structure according to the above configuration (8), in the cross-section including the first direction and the second direction, at least a part of the second wall section extends along a direction (such as the extension direction of the fifth inclined wall portion 42, the extension direction of the sixth inclined wall portion 44, and the extension direction of the seventh inclined wall portion 46 shown in FIG. 9) intersecting with the first direction.

With the cooling channel structure according to the above configuration (9), since at least the part of the second wall section extends along the direction intersecting with the first direction, it is possible to suppress the damage to the first wall section and the third wall section caused by the thermal stress by reducing the constraint force of the thermal deformation in the first direction received from the second wall section by the first wall section and the third wall section.

(10) In some embodiments, in the cooling channel structure according to the above configuration (8) or (9), in the cross-section including the first direction and the second direction, the partition wall sections connecting the first wall section and the second wall section extend from the first wall section to the second wall section in the direction intersecting with the second direction, and the partition wall sections connecting the second wall section and the third wall section extend from the third wall section to the second wall section in the direction intersecting with the second direction.

With the cooling channel structure according to the above configuration (10), it is possible to effectively suppress the damage to the first wall section by effectively reducing the constraint force of the thermal deformation received from the partition wall section by the first wall section.

(11) A burner according to the present disclosure includes the cooling channel structure according to any one of the above configurations (1) to (10).

Since the burner according to the above configuration (11) includes the cooling channel structure according to any one of the above configurations (1) to (10), compared with the configuration where the partition wall sections extend in parallel to the second direction (the direction orthogonal to the first direction), it is possible to suppress the damage to the first wall section caused by the thermal stress by reducing the constraint force of the thermal deformation received from the partition wall sections by the first wall section, while maintaining the density of the cooling channel. Thus, it is possible to suppress damage to the burner.

(12) A heat exchanger according to the present disclosure includes the cooling channel structure according to any one of the above configurations (1) to (10).

Since the heat exchanger according to the above configuration (12) includes the cooling channel structure according to any one of the above configurations (1) to (10), compared with the configuration where the partition wall sections extend in parallel to the second direction (the direction orthogonal to the first direction), it is possible to suppress the damage to the first wall section caused by the thermal stress by reducing the constraint force of the thermal deformation received from the partition wall sections by the first wall section, while maintaining the density of the cooling channel. Thus, it is possible to suppress damage to the heat exchanger.

### REFERENCE SIGNS LIST

2 Burner
4 Fuel nozzle
5 (5A-5E) Burner tube
6 First wall section
8 Second wall section
10 Partition wall section
12 Channel cross-section
14 Cooling channel
16 First inclined wall portion
18 Second inclined wall portion
20 Third wall section
22 Partition wall section
26 Combustion chamber
28 Wall
30 Swirler
32 Channel cross-section
34 Cooling channel
36 Third inclined wall portion
38 Fourth inclined wall portion 40 Connecting portion
42 Fifth inclined wall portion
44 Sixth inclined wall portion
46 Seventh inclined wall portion
48 Bent wall portion
50 Nozzle skirt
52 Water wall
100A-100G Cooling channel structure

1-12. (canceled)

13. A cooling channel structure, comprising:
a first wall section extending along a first direction;
a second wall section disposed at an interval from the first wall section in a second direction orthogonal to the first direction;
at least one cooling channel which has a plurality of channel cross-sections disposed at intervals in the first direction, the cooling channel being formed between the first wall section and the second wall section; and
a plurality of partition wall sections disposed in the cooling channel, connecting the first wall section and the second wall section, and forming a wall surface of the cooling channel,
wherein, in a cross-section including the first direction and the second direction, at least a part of each of the partition wall sections extends along a direction intersecting with the second direction,
wherein, in the cross-section including the first direction and the second direction, each of the partition wall sections includes:
a first inclined wall portion extending from the first wall section in a third direction intersecting with the second direction; and
a second inclined wall portion extending from the second wall section in a fourth direction intersecting with each of the second direction and the third direction to be connected to the first inclined wall portion.

14. The cooling channel structure according to claim 13,
wherein each of the partition wall sections includes the first inclined wall portion and the second inclined wall portion, and
wherein the third direction is a direction toward one side in the first direction with increasing distance from the first wall section, and the fourth direction is a direction toward the above-described one side in the first direction with increasing distance from the second wall section.

15. The cooling channel structure according to claim 13,
wherein each of the first wall section and the second wall section is formed into a tubular shape, and
wherein the second wall section is disposed on an inner peripheral side of the first wall section.

16. The cooling channel structure according to claim 13,
wherein each of the first wall section and the second wall section is formed along a plane.

17. The cooling channel structure according to claim 13, further comprising:
a third wall section disposed opposite to the first wall section across the second wall section; and
a plurality of partition wall sections connecting the second wall section and the third wall section so as to form at least one cooling channel between the second wall section and the third wall section, the cooling channel having a plurality of channel cross-sections disposed at intervals in the first direction,
wherein, in the cross-section including the first direction and the second direction, at least a part of each of the partition wall sections connecting the second wall section and the third wall section extends along the direction intersecting with the second direction.

18. The cooling channel structure according to claim 17,
wherein, in the cross-section including the first direction and the second direction, at least a part of the second wall section extends along a direction intersecting with the first direction.

19. The cooling channel structure according to claim 17,
wherein, in the cross-section including the first direction and the second direction,
the partition wall sections connecting the first wall section and the second wall section extend from the first wall section to the second wall section in the direction intersecting with the second direction, and
the partition wall sections connecting the second wall section and the third wall section extend from the third wall section to the second wall section in the direction intersecting with the second direction.

20. A burner comprising the cooling channel structure according to claim 13,
wherein the first direction is an axial direction of the burner, and the second direction is a radial direction of the burner.

21. A heat exchanger comprising the cooling channel structure according to claim 13.
